(19) United States
(12) Patent Application Publication
(10) Pub. No.: US 2010/0262937 A1
(43) Pub. Date: Oct. 14, 2010

(54) APPLICATION PROGRAM

(75) Inventor: Kimihiro Kawano, Matsumoto-shi (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: SEIKO EPSON CORPORATION, Shinjuku-ku (JP)

(21) Appl. No.: 12/756,899

(22) Filed: Apr. 8, 2010

(30) Foreign Application Priority Data
Apr. 9, 2009 (JP) 2009-094643

(51) Int. Cl. G06F 3/048

(52) U.S. Cl. 715/810

(57) ABSTRACT

An application program causing a computer to function as: a processing sequence launching unit that, in the case where in a menu in which processing sequences associated with a first device are displayed as choices by a browser, a processing sequence from among the processing sequences associated with the first device is selected, launches the selected processing sequence; a processing target candidate selection display unit that displays a list of processing target candidates as choices; and a processing target specification unit that, in the case where one or more of the processing target candidates has been selected, passes the selected processing target candidate as a processing target to the processing sequence launched by the processing sequence launching unit.

### BACKGROUND

1. Technical Field

The present invention relates to application programs, and particularly relates to application programs that are launched when a specific processing sequence has been selected in a menu of a webpage displayed by a browser.

2. Related Art

As a past technique for facilitating operations for selecting a desired processing target and a desired processing sequence, a technique whereby, for example, when a shortcut icon for a file placed on the desktop is double-clicked, the file is opened by an application program associated in advance with the extension of that file, is known.

Meanwhile, with Device Stage, which is a device settings window in the latest version of Windows®, a menu that offers selections for various processing sequences associated with a single device based on XML documents provided in the device header is displayed by a browser. With Device Stage, for example, a menu that offers printing, viewing photographic images, displaying the remaining amount of ink, and so on as selections for processing sequences associated with a printer can be displayed (see JP-A-2005-49929).

However, with the past techniques, it has been necessary, after selecting a processing target, to select a device-unique processing sequence with respect to the selected processing target. For example, a user who wishes to print a specific photographic image double-clicks the shortcut icon for a file placed on the desktop, thereby launching an application program with that file in an editable state. However, in order to print that file, save that file into a removable memory, or the like, it is necessary for the user to select a device-unique processing sequence, such as printing or saving, within the application program that has been launched. Furthermore, for example, assume that a user who wishes to print a specific photographic image has launched Device Stage for a specific printer. As a result, a menu that displays selections such as printing, viewing photographic images, displaying the remaining amount of ink, and so on as processing sequences associated with the printer is displayed in Device Stage. Next, assume that the user selects viewing photographic images, thereby launching an application program for viewing photographic images, and then selects a photographic image to be processed within the launched application program. However, despite the fact that the user has displayed Device Stage for a specific printer with the intent to carry out printing, the printer displayed in Device Stage cannot be caused to print the photographic image unless printing has been selected in the launched application program.

### SUMMARY

An advantage of some aspects of the invention is to ease operations for selecting a desired processing target and a device-unique processing sequence.

1 An application program according to an aspect of the invention causes a computer to function as: a device launching unit that, in the case where in a menu in which one or more processing sequences associated with a first device are displayed as choices by a browser, a processing sequence from among the processing sequences associated with the first device is selected, launches a processing sequence undertaken by the first device; and a processing target specification unit that displays one or more processing target candidates as a list of choices and passes one or more processing target candidates that has been selected from among the one or more processing target candidates as a processing target to the processing sequence undertaken by the first device.

According to this aspect of the invention, if the user selects a desired processing sequence in a menu in which one or more processing sequences are displayed in a browser as choices, it is unnecessary to once again the device-unique processing sequence in the application program for selecting the processing target. Accordingly, according to this aspect of the invention, operations for selecting a desired processing target and a device-unique processing sequence can be eased.

2 In an application program according to another aspect of the invention, the processing target specification unit may display the one or more processing target candidates as choices immediately after a predetermined processing sequence from among the one or more processing sequences has been selected.

3 Meanwhile, there are cases where a series of processing sequences requested by the user includes two processing sequences undertaken by two devices, and at least one of the devices undertakes multiple processing sequences. For example, there are cases where a file saved in a mobile storage device is copied into a removable memory that is connected to a printer.

Accordingly, an application program according to another aspect of the invention may cause the computer to function as a browser control unit that, in the case where in a menu in which one or more processing sequences associated with a second device are displayed as choices by a browser, a processing sequence from among the one or more processing sequences associated with the second device that is also associated with a first device is selected, displays a menu of the one or more processing sequences associated with the first device in the browser. In the case where a predetermined processing sequence that is also associated with the first device has been selected from among the one or more processing sequences associated with the second device, the processing target specification unit may display the one or more processing target candidates as choices by launching a predetermined processing sequence undertaken by the second device.

Through this, if the respective desired processing sequences are selected in the two menus in which multiple processing sequences are displayed as choices by the browser, it is unnecessary to once again select the device-unique processing sequence in the application program for selecting the processing target. Accordingly, according to this aspect of the invention, operations for selecting a desired processing target and a device-unique processing sequence can be eased.

Note that the application program of the invention can also be implemented as a storage medium. Of course, that storage medium may be a magnetic storage medium, a magneto-optical storage medium, or any storage medium that may be developed in the future.

### BRIEF DESCRIPTION OF THE DRAWINGS

The invention will be described with reference to the accompanying drawings, wherein like numbers reference like elements.

FIG. 1 is a block diagram according to an embodiment of the invention.

FIGS. 2A and 2B are window diagrams according to an embodiment of the invention.

FIGS. 3A and 3B are window diagrams according to an embodiment of the invention.

FIGS. 4A and 4B are window diagrams according to an embodiment of the invention.

FIG. 5 is a sequence chart according to an embodiment of the invention.

FIG. 6 is a sequence chart according to an embodiment of the invention.

FIG. 7 is a sequence chart according to an embodiment of the invention.

### DESCRIPTION OF EXEMPLARY EMBODIMENTS

Embodiments of the invention will be described hereinafter with reference to the appended drawings. Constituent elements that correspond to each other in the diagrams will be given identical reference numerals, and redundant descriptions thereof will be omitted.

### A First Embodiment

### 1 Configuration of Application Program

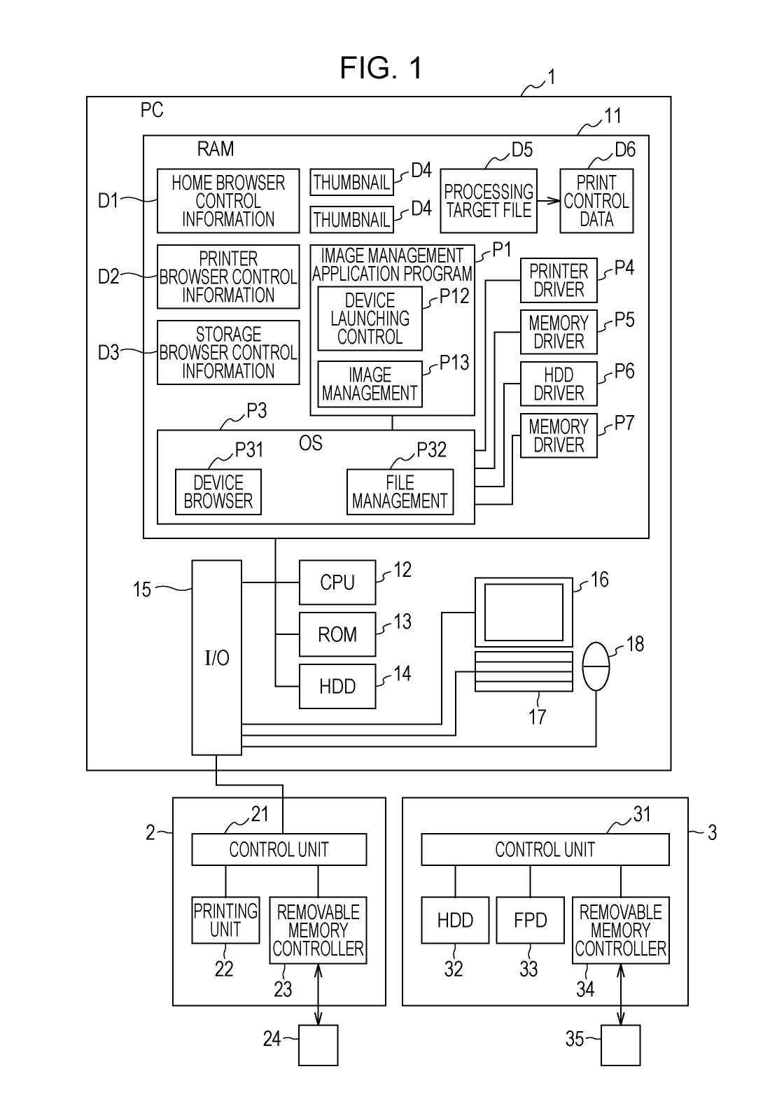

FIG. 1 is a block diagram illustrating a PC (personal computer) 1 that executes an image management application serving as an embodiment of the application program of the invention, as well as a printer 2 and a storage device 3 that are connected to the PC 1.

The printer 2 includes a printing unit 22, a removable memory controller 23, and a control unit 21 for controlling the printing unit 22 and the removable memory controller 23. The printing unit 22 is a mechanism that forms an image by expelling ink onto a printing medium. A data file stored in the PC 1 and a removable memory 24 serve as the target of the printing performed by the printing unit 22. The printing unit 22 controls the amount of ink expelled onto the printing medium on a pixel-by-pixel basis based on print control data generated from the data file stored in the PC 1 and the removable memory 24. The removable memory controller 23 is an electronic circuit for writing data files into the removable memory 24 that is connected to the removable memory controller 23, and reading out data files from the removable memory 24. The control unit 21 is a microcomputer that includes a RAM, a CPU, a ROM, and an input/output mechanism (not shown). The printing unit 22 and the removable memory controller 23 are connected to the input/output mechanism of the control unit 21. The control unit 21 controls the printing unit 22 and the removable memory controller 23 based on the print control data received from the PC 1, as well as other control signals.

The storage device 3 is a mobile device for importing and displaying raster image files saved in a digital camera, the PC 1, or the like. The storage device 3 includes a hard disk device (HDD) 32, an FPD (flat panel display) 33, a removable memory controller 34, and a control unit 31 that controls the HDD 32, FPD 33, and removable memory controller 34. The removable memory controller 34 is an electronic circuit that reads the raster image files stored in the digital camera or the like from a removable memory 35 connected to the removable memory controller 34, and writes data files into the removable memory 35. The FPD 33 is a display device, configured of a liquid crystal panel, a driving circuit, and the like, for displaying the raster image files read from the removable memory 35. The control unit 31 is a microcomputer that includes a RAM, a CPU, a ROM, and an input/output mechanism (not shown). The hard disk device 32, the FPD 33, the removable memory controller 34, and an operation device (a touchpad or the like; not shown) are connected to the input/output mechanism of the control unit 31. The control unit 31 controls the hard disk device 32, the FPD 33, and the removable memory controller 34 in accordance with requests inputted via the operation device, control signals received from the PC 1, and so on.

The PC 1 includes a RAM 11, a CPU 12, a ROM 13, an input/output mechanism (I/O) 15, and a hard disk device (HDD) 14. A display 16, a keyboard 17, and a mouse 18 for operating the PC 1 are connected to the input/output mechanism (I/O) 15, and furthermore, peripheral devices such as the printer 2, the storage device 3, and so on can be connected to the input/output mechanism (I/O) 15. Computer programs such as an operating system P3, an image management application program P1, a printer driver P4, a memory driver P5, an HDD driver P6, a memory driver P7, and so on are stored in the hard disk device 14 of the PC 1. These computer programs are loaded into the RAM 11 and executed by the CPU 12, and it is thereby that the PC 1 functions as a control apparatus that controls peripheral devices such as the printer 2, the storage device 3, and so on.

The operating system P3 includes a device browser P31 that implements a common GUI environment for controlling the peripheral devices, and a file management module P32 that realizes a GUI environment for accessing a file system. The device browser P31 realizes a function for displaying a menu in which multiple processing sequences associated with respective peripheral devices are provided as choices, based on XML documents such as home browser control information D1, printer browser control information D2, storage browser control information D3, and so on. To be more specific, link information leading to multiple XML documents for displaying respective menus associated with the specific peripheral devices of the printer browser control information D2, the storage browser control information D3, and so on are written into the home browser control information D1. The file management module P32 manages a database that associates data file extensions with application programs. Hereinafter, it is assumed that in this database, the extension for raster image files is associated with the image management application program P1.

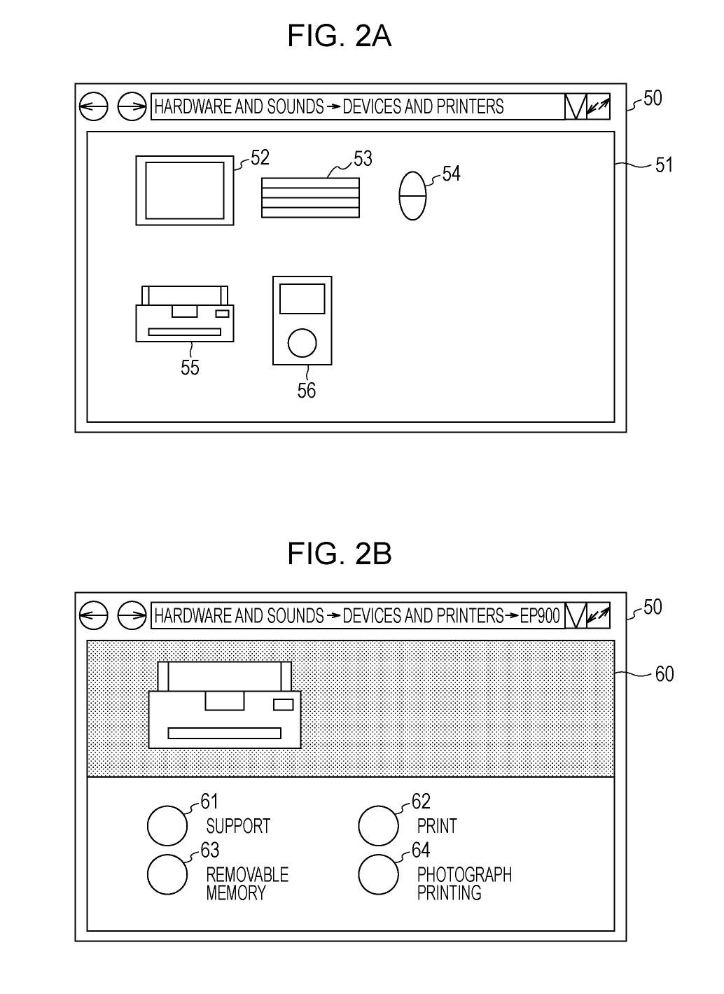

FIG. 2A is a diagram illustrating an example of a device home page displayed by the device browser P31 based on the home browser control information D1. The device browser P31 displays, in a window 50, a device home page 51 serving as a list of peripheral devices connected to the PC 1. Icons 52, 53, 54, 55, and 56, indicating the external appearance of peripheral devices, are displayed in the device home page 51. Links to XML documents defining menus in which multiple processing sequences associated with the respective peripheral devices are displayed as choices are defined for respective regions in which the icons 52, 53, 54, 55, and 56 are displayed. For example, a path for accessing the printer browser control information D2 is defined for a region in which the icon 55, which expresses an external appearance of the printer 2, is displayed. Accordingly, when the icon 55 is clicked, the device browser P31 displays, in the window 50, a menu in which processing sequences associated with the printer 2 are provided as choices, based on the printer browser control information D2. Meanwhile, a path for accessing the storage browser control information D3 is defined for a region in which the icon 56, which expresses an external appearance of the storage device 3, is displayed. Accordingly, when the icon 56 is clicked, the device browser P31 displays, in the window 50, a menu associated with the storage device 3, based on the storage browser control information D3.

A computer program group for controlling the printer 2 is configured from the printer driver P4 and the memory driver P5. The printer driver P4 converts a raster image generated from a data file that is to be printed into print control data and sends the print control data to the printer 2, thereby realizing a function for causing the printer 2 to print the data file that is to be printed. In other words, the printer driver P4 is a program for controlling a print processing sequence undertaken by the printing unit 22 of the printer 2. Meanwhile, the memory driver P5 displays the data files stored in the removable memory 24 as a selectable list of processing target candidates, and realizes a function for causing the printer 2 to read out data files stored in the removable memory 24 that are to be copied/moved and send those data files to the PC 1, as well as a function for causing data files that are to be copied/moved to be sent to the printer 2 and causing the printer 2 to write data files that are to be copied/moved into the removable memory 24. In other words, the memory driver P5 is an application program for controlling a file manipulation processing sequence undertaken by the removable memory controller 23 of the printer 2.

Thus a menu by which a user selects and launches such processing sequences associated with the printer 2 is displayed based on the printer browser control information D2 for controlling the device browser P31. To be more specific, multiple pieces of link information for directly or indirectly launching the processing sequences undertaken by the printer driver P4 and the memory driver P5 are written in the printer browser control information D2 as a printer launching unit.

FIG. 2B is a diagram illustrating a printer page, serving as a menu, displayed by the device browser P31 based on the printer browser control information D2. A diagram illustrating external appearances of the printer 2, icons 61, 62, 63, and 64 depicting buttons for launching respective multiple processing sequences associated with the printer 2, and text describing the processing sequences launched when the icons 61, 62, 63, and 64 are clicked, are displayed in a printer page 60. Corresponding processing sequences are associated with respective regions in which the icons 61, 62, 63, and 64 are displayed. For example, a pointer to a file manager module P32 of the operating system P3 is defined for the region in which the icon 62, which is described by text reading “print”, is displayed. Meanwhile, a pointer to the memory driver P5 is defined for a region in which the icon 63, which is described by text reading “removable memory”, is displayed. Furthermore, a pointer to the image management application program P1 is defined for a region in which the icon 64, which is described by text reading “photograph print”, is displayed.

A computer program group for controlling the storage device 3 is configured from the HDD driver P6 and the memory driver P7. The HDD driver P6 displays the data files stored in the hard disk device 32 as a selectable list of processing target candidates, and realizes a function for causing the storage device 3 to read out data files stored in the hard disk device 32 and send those data files to the PC 1, as well as a function for sending data files that are to be copied/moved to the storage device 3 and causing the storage device 3 to write the data files that are to be copied/moved into the hard disk device 32. In other words, the HDD driver P6 is an application program for controlling a file manipulation processing sequence undertaken by the hard disk device 32 of the storage device 3. Meanwhile, the memory driver P7 displays the data files stored in the removable memory 35 as a selectable list of processing target candidates, and realizes a function for causing the storage device 3 to read out data files stored in the removable memory 35 that are to be copied/moved and send those data files to the PC 1, and a function for sending data files that are to be copied/moved from the PC 1 to the storage device 3 and causing the storage device 3 to write the data files that are to be copied/moved into the removable memory 35. In other words, the memory driver P7 is an application program for controlling file manipulation processing sequences undertaken by the removable memory controller 34 of the storage device 3.

Thus a menu by which a user selects and launches such processing sequences associated with the storage device 3 is displayed based on the storage browser control information D3 for controlling the device browser P31. To be more specific, multiple pieces of link information for directly or indirectly launching the processing sequences undertaken by the HDD driver P6 and the memory driver P7 are written in the storage browser control information D3 as a storage device launching unit.

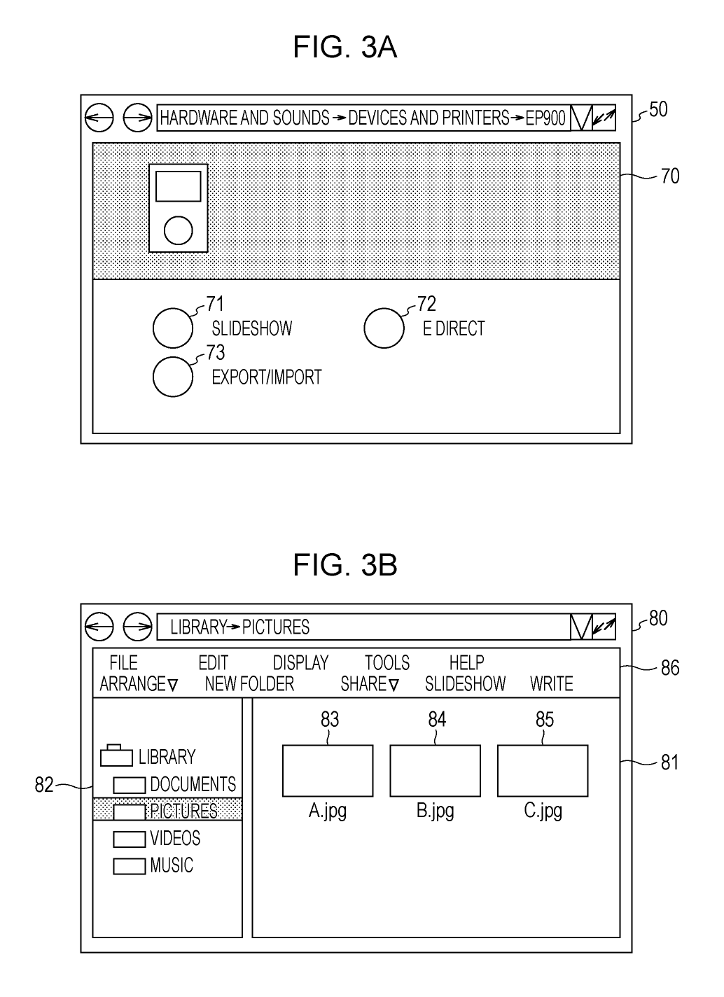

FIG. 3A is a diagram illustrating a storage page, serving as a menu, displayed by the device browser P31 based on the storage browser control information D3. A diagram illustrating external appearances of the storage device 3, icons 71, 72, and 73 depicting buttons for launching respective multiple processing sequences associated with the storage device 3, and text describing the processing sequences launched when the icons 71, 72, and 73 are clicked, are displayed in a storage page 70. Corresponding processing sequences are associated with respective regions in which the icons 71, 72, and 73 are displayed. For example, a pointer to the HDD driver P6 is defined for a region in which the icon 72, which is described by text reading “E direct”, is displayed. Meanwhile, a pointer to the HDD driver P6 is defined a the region in which the icon 73, which is described by text reading “import/export”, is displayed. Although it should be noted that the processing sequences launched when the icons 72 and 73 are clicked are different, this will be described later.

The image management application program P1 includes program module groups, such as an image management module P13, a device launching control module P12, and so on. The image management module P13 displays multiple raster image files as a list of processing target candidates, and realizes a function for sequentially displaying one or more selected raster image files as a slideshow, printing raster image files, and so on. The device launching control module P12 realizes a function for launching a processing sequence undertaken by the printer 2, using one or more raster image files from among the selected processing target candidates as a target/targets for processing.

### 2 Peripheral Device Control Process

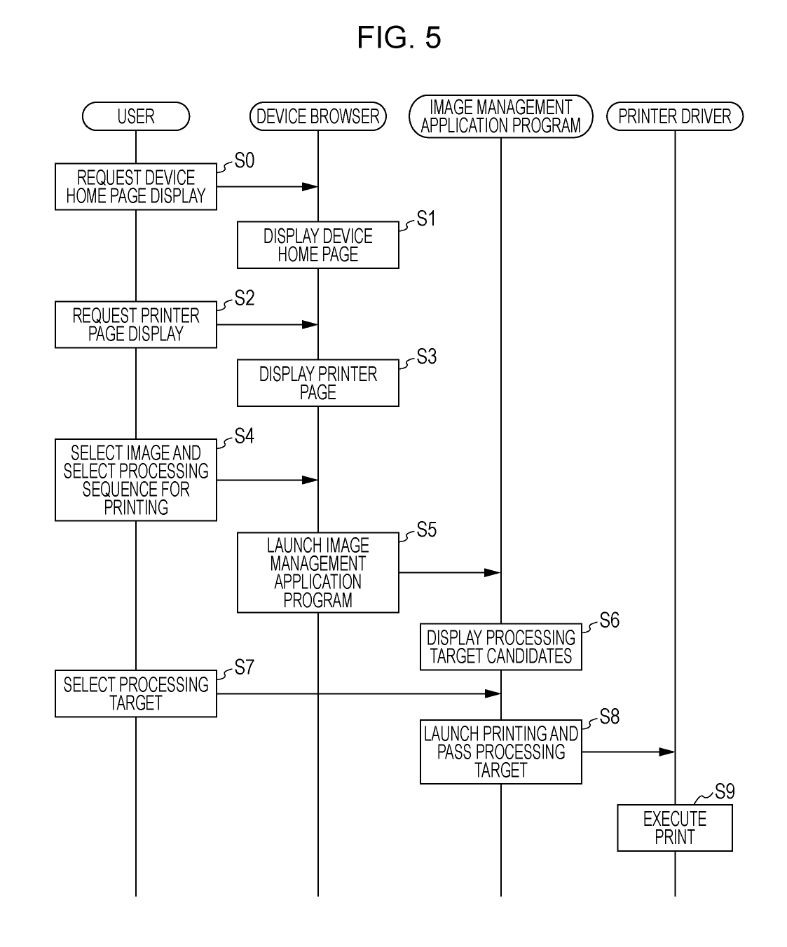

FIG. 5 is a sequence chart illustrating a first embodiment of a peripheral device control process. Of the processes illustrated in FIG. 5, the processes of S1, S3, and S5 are controlled by the device browser P31, the processes of S6 and S8 are controlled by the image management application program P1, and the process of S9 is controlled by the printer driver P4.

The processing illustrated in FIG. 5 commences as a result of a user inputting, to the PC 1, a device home page display request, via the GUI of the operating system P3 (S0).

When the device home page display request is inputted to the PC 1, the device home page 51 illustrated in FIG. 2A is displayed in the screen of the display 16 by the device browser P31, based on the home browser control information D1.

Next, when the user requests the device browser P31 to display the printer page (S2), a menu in which the multiple processing sequences associated with the printer 2 are provided as choices is displayed (S3). To be more specific, when the icon 55 displayed in the device home page 51 and expressing the external appearance of the printer 2 is clicked, the printer page 60 illustrated in FIG. 2B is displayed in the screen of the display 16 by the device browser P31, based on the printer browser control information D2.

Next, when a processing sequence for selecting a raster image file and printing the raster image file is selected by the user from among the multiple processing sequences associated with the printer 2 (S4), the image management application program P1 is launched (S5). To be more specific, when the icon 64 displayed in the printer page 60 and described by the text reading “photograph printing” is clicked, the image management application program P1 is launched.

When the processing sequence for selecting a raster image file and printing the raster image file is selected, multiple processing target candidates are displayed as a list of choices (S6). To be more specific, a window 80 as illustrated in FIG. 3B, for example, is displayed in the screen of the display 16 by the image management application program P1. A subwindow 81 in which a menu providing a list of the multiple processing target candidates as choices is configured, a subwindow 82 in which a folder tree is displayed, and a menu bar 86 for selecting a processing sequence to be processed are arranged in the window 80. Thumbnail images 83, 84, and 85 of raster image files serving as processing target candidates present in the current folder are displayed in the subwindow 81. The original images of the raster image files are associated with respective regions in which the thumbnail images 83, 84, and 85 are displayed via file paths. In the subwindow 82, folders defined in a specific volume are displayed as choices, and the currently selected folder (current folder) is displayed therein with highlighting.

Next, when the user selects one or more processing targets from among the multiple processing target candidates (S7), a print processing sequence is launched, and the selected processing target is passed to the print processing sequence (S8). To be more specific, when one or more of the thumbnail images 83, 84, and 85 displayed in the subwindow 81 is clicked, the print processing sequence controlled by the printer driver P4 is launched, and the original images of the raster image files associated with the clicked thumbnail images 83, 84, and 85 are decoded, rasterized, and then passed to the printer driver P4.

The processing sequence launched by the image management application program P1 when one or more of the thumbnail images 83, 84, and 85 displayed in the subwindow 81 is clicked differs depending on the cause for launching the image management application program P1. In other words, in the case where the image management application program P1 was launched from the printer page 60 of the device browser P31, when one or more of the thumbnail images 83, 84, and 85 displayed in the subwindow 81 is clicked, the print processing sequence is launched by the image management application program P1. However, in the case where the image management application program P1 was not launched from the printer page 60, clicking one or more of the thumbnail images 83, 84, and 85 displayed in the subwindow 81 simply sets the clicked thumbnail images as processing targets; and as long as the print processing sequence is not selected as the processing sequence for the processing targets (for example, as long as the print processing sequence is not selected from the file menu of a menu bar 86), the print processing sequence is not launched.

Accordingly, a process that causes the processing sequences launched by the image management application program P1 to branch can be realized, for example, as follows. First, identification information by which the launch control module P12 specifies the cause of the launch when the image management application program P1 is launched (for example, the path of the printer page 60, an identifier of the printer 2, or the like) is obtained from the device browser P31 and stored in a predetermined region of the RAM 11. Then, when one or more of the thumbnail images 83, 84, and 85 is clicked, the image management module P13 obtains the identification information stored in that predetermined region, and causes the processing to branch based on the obtained identification information.

Finally, the processing target selected in S4 is printed by the print processing sequence that has been launched (S9). To be more specific, the rasterized raster image file is converted into print control data, the print control data is sent from the PC 1 to the printer 2, and the printer 2 executes the printing based on the print control data.

According to the embodiment of the peripheral device control process as described thus far, if a user uses a menu, in which multiple processing sequences associated with the printer 2 are displayed as choices by the device browser P31, to select an image and select a processing sequence for printing, it is unnecessary to once again select a print processing sequence unique to the printer 2 using a GUI of the image management application program P1 for selecting a processing target.

### B Second Embodiment

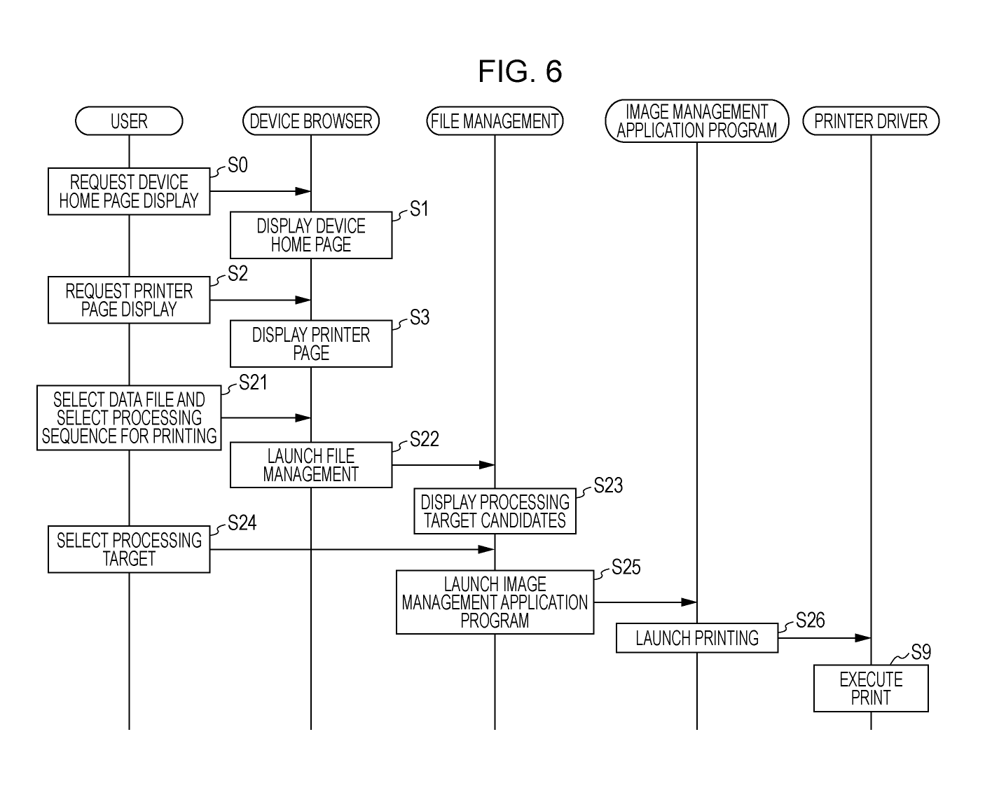

FIG. 6 is a sequence chart illustrating a second embodiment of a peripheral device control process. Of the processes illustrated in FIG. 6, the process of S22 is controlled by the device browser P31, the processes of S23 and S25 are controlled by the file management module P32, and the process of S26 is controlled by the image management application program P1.

In a state in which the printer page 60 is displayed by the device browser P31 (S3), when an arbitrary data file is selected and a processing sequence for printing is selected (S21), the file manager module P32 of the operating system P3 is launched (S22). To be more specific, when an icon 64 displayed in the printer page 60 and described by the text reading “print” is clicked, the file manager module P32 is launched.

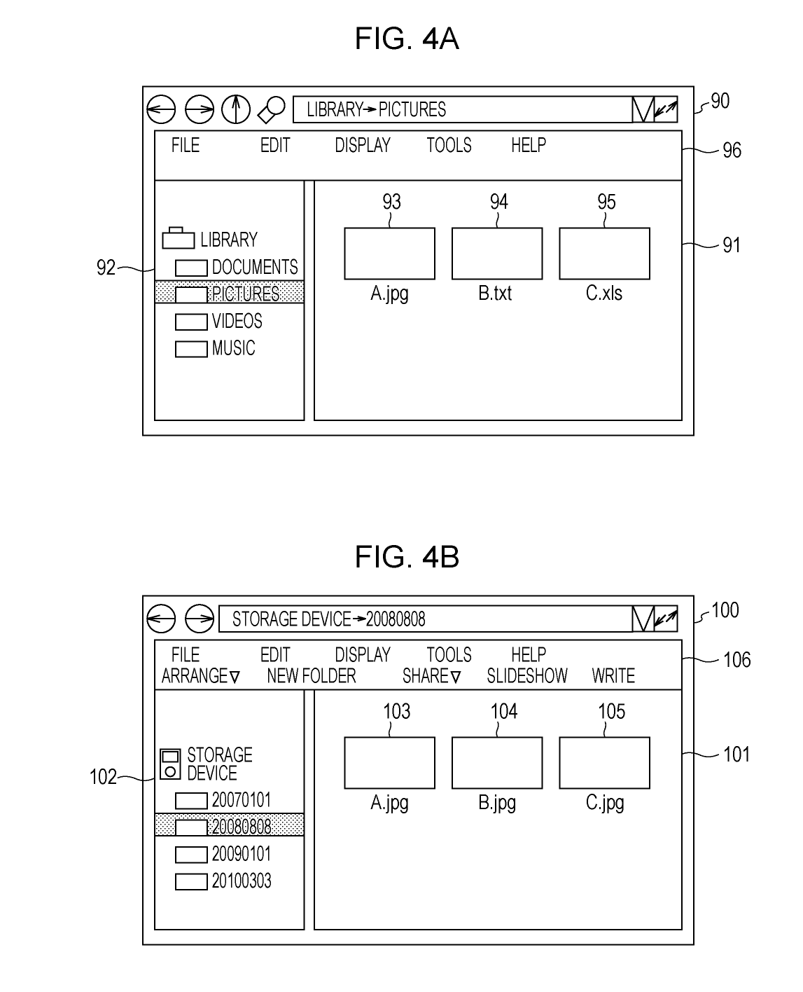

When the file manager module P32 is launched, a menu providing a list of multiple processing target candidates as choices is displayed (S23). To be more specific, a window 90 as illustrated in FIG. 4A, for example, is displayed by the file manager module P32. A subwindow 91 in which a menu providing a list of the multiple processing target candidates as choices is configured, a subwindow 92 in which a folder tree is displayed, and a menu bar 96 for selecting a processing sequence to be processed are arranged in the window 90. Shortcut icons 93, 94, 95 leading to data files serving as processing target candidates present in the current folder are displayed in the subwindow 91. Specific data files are associated with respective regions in which the shortcut icons 93, 94, 95 are displayed via file paths. In the subwindow 92, folders defined in a specific volume are displayed as choices, and the currently selected folder (current folder) is displayed therein with highlighting.

Next, when the user selects one or more of the multiple processing target candidates as a processing target (S24), the application program corresponding to the selected processing target is launched (S25). For example, if a raster image file has been selected as the processing target, the image management application program P1 is launched. To be more specific, when the shortcut icon 93 of a raster image file arranged in the window 90 is double-clicked, the image management application program P1, which is associated with the raster image file extension “.jpg” in the database managed by the file manager module P32, is launched.

When the image management application program P1 is launched, a print processing sequence is launched, and the processing target selected in S24 is passed to the print processing sequence (S26). To be more specific, when the image management application program P1 is launched, a print processing sequence controlled by the printer driver P4 is launched, and the original image of the raster image file associated with the shortcut icon 93 that has been clicked is decoded, rasterized, and passed to the printer driver P4.

The processing sequence launched when the image management application program P1 is launched is dependent on the cause of the launching of the image management application program P1. In other words, when the image management application program P1 is launched from the printer page 60 of the device browser P31 via the window 90 of the file management module P32, the print processing sequence is launched. However, if the image management application program P1 is not launched via the printer page 60 of the device browser P31, the window 90 will simply be displayed in the screen of the display 16 even if the image management application program P1 is launched.

Accordingly, a process that causes the processing sequences launched by the image management application program P1 to branch can be realized, for example, as follows. First, a function for monitoring the icons that are clicked in the printer page 60 displayed by the device browser P31 is added to the device launching control module P12 of the image management application program P1, and the device launching control module P12 is launched and runs in the background immediately after the PC 1 is started up. Identification information that specifies the cause of the launch in accordance with the icon clicked in the printer page 60 (for example, an identifier of the icon 62 displayed in the printer page 60) is obtained from the device browser P31 and stored in another predetermined region of the RAM 11. Then, when the image management module P13 is launched, the identification information stored in that predetermined region is obtained, and the processing is caused to branch based on the obtained identification information.

Finally, the processing target selected in S24 is printed by the print processing sequence that has been launched (S9).

According to the second embodiment of the peripheral device control process as described thus far, if a user selects a desired data file and selects a processing sequence for printing in the print page 60, in which multiple processing sequences associated with the printer 2 our displayed as choices by the device browser P31, and selects a processing target in the window 90 displayed by the file management module P32, it is unnecessary to once again select a processing target using a GUI of the image management application program P1 for selecting a processing target, once again select a print processing sequence unique to the printer 2, and so on.

### C Third Embodiment

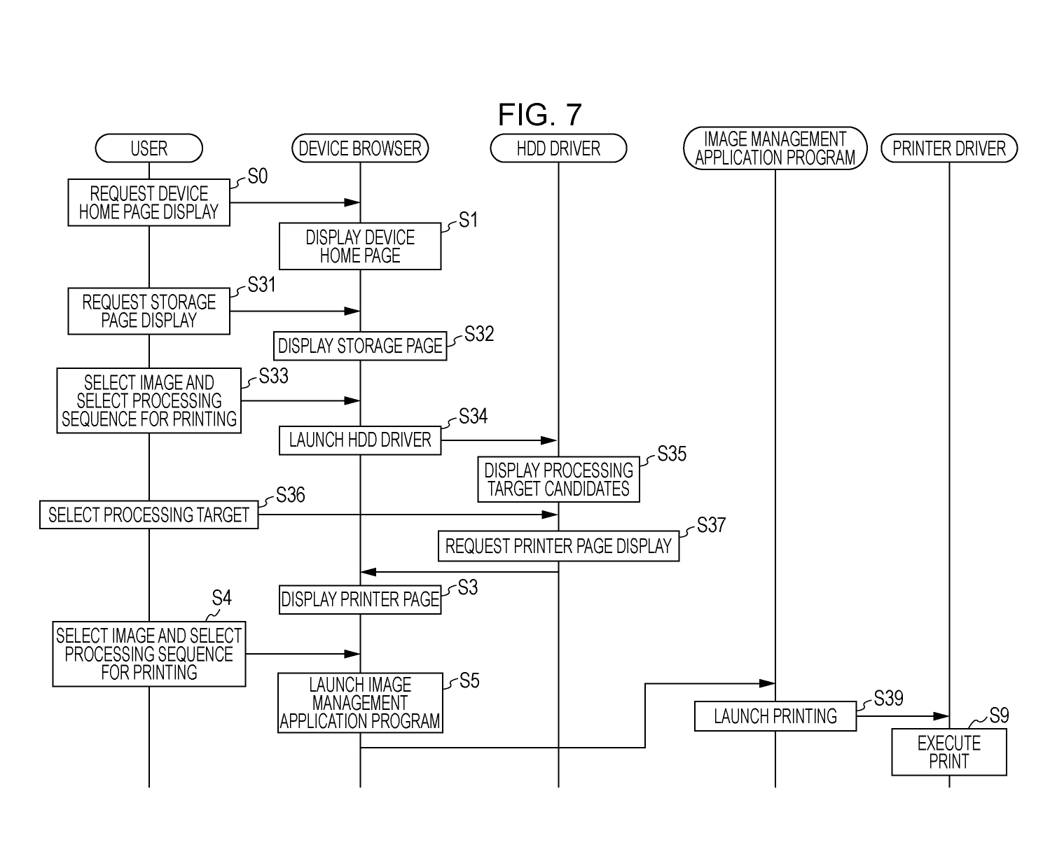

FIG. 7 is a sequence chart illustrating a third embodiment of the peripheral device control process. Of the processes illustrated in FIG. 7, the processes of S32 and S34 are controlled by the device browser P31, the processes of S35 and S37 are controlled by the HDD driver P6, and the process of S39 is controlled by the image management application program P1.

In a state in which the device home page 51 is being displayed by the device browser P31 (S1), when a user requests the device browser P31 to display the storage page (S31), a menu in which the multiple processing sequences associated with the storage device 3 are provided as choices is displayed (S32). To be more specific, what an icon 56 displayed in the device home page 51 and expressing the external appearance of the storage device 3 is clicked, the storage page 70 as illustrated in FIG. 3A is displayed by the device browser P31 based on the storage browser control information D3.

Next, in the case where of the multiple processing sequences associated with the storage device 3, a processing sequence for selecting an image and printing the image is selected as a predetermined processing sequence also associated with the printer 2, a predetermined processing sequence undertaken by the storage device 3 is launched (S34). To be more specific, for example, when the icon 72, which is described by text reading “E direct”, is clicked in the storage page 70, the HDD driver P6 is launched.

When the HDD driver P6 is launched, multiple processing target candidates are displayed (S35). To be more specific, a window 100 illustrated in FIG. 4B, for example, is displayed in the screen of the display 16 by the HDD driver P6. A subwindow 101 in which a menu providing a list of the multiple processing target candidates as choices is configured, a subwindow 102 in which a folder tree is displayed, and a menu bar 106 for selecting a processing sequence to be processed are arranged in the window 100. Thumbnail images 103, 104, and 105 of raster image files serving as processing target candidates present in the current folder are displayed in the subwindow 101. The original images of the raster image files are associated with respective regions in which the thumbnail images 103, 104, and 105 are displayed via file paths. In the subwindow 102, folders defined in the hard disk device 32 of the storage device 3 are displayed as choices, and the currently selected folder (current folder) is displayed therein with highlighting.

Next, when the user selects one or more of the multiple processing target candidates as a processing target (S36), the HDD driver P6 requests the device browser P31 to display a menu of the multiple processing sequences associated with the printer 2 (S37). To be more specific, when one or more of the thumbnail images 103, 104, and 105 displayed in the subwindow 101 is clicked, the HDD driver P6 requests the device browser P31 to display the printer page 60.

The processing sequence launched when one or more of the thumbnail images 103, 104, and 105 displayed in the subwindow 81 is clicked depends on the cause for launching the HDD driver P6. In other words, in the case where the HDD driver P6 has been launched from the icon 72 in the storage page 70 of the device browser P31, when one or more of the thumbnail images 103, 104, and 105 displayed in the subwindow 101 is clicked, the HDD driver P6 requests the device browser P31 to display the menu of the multiple processing sequences associated with the printer 2. However, in the case where the HDD driver P6 has not been launched from a icon 72 in the storage page 70 of the device browser P31 (for example, in the case where the icon 73 described by text reading “export/import” in the storage page 70 has been clicked), clicking one or more of the thumbnail images 103, 104, and 105 displayed in the subwindow 101 simply displays a list of processing target candidates, and no request is made to display the menu of the multiple processing sequences associated with the printer 2.

Accordingly, a process that causes the processing sequences launched by the HDD driver P6 to branch can be realized, for example, as follows. First, identification information by which the HDD driver P6 specifies the cause of the launch when the HDD driver P6 is launched (for example, an identifier of the icon 72 arranged in the storage page 70) is obtained from the device browser P31 and stored in a predetermined region of the RAM 11. Then, when one or more of the thumbnail images 103, 104, and 105 is clicked, the HDD driver P6 obtains the identification information stored in the predetermined region, and causes the processing to branch based on the obtained identification information.

Next, a menu in which the multiple processing sequences associated with the printer 2 are provided as choices is displayed (S3). To be more specific, the printer page 60 is displayed in the screen of the display 16 by the device browser P31, based on the printer browser control information D2.

Next, when of the multiple processing sequences associated with the printer 2, a processing sequence that selects an image and prints the image is selected by the user (S4), the image management application program P1 is launched (S5). To be more specific, when the icon 64 displayed in the print page 60 and described by text reading “photograph printing” is clicked, the image management application program P1 is launched.

When the image management application program P1 is launched, a print processing sequence is launched, and the processing target selected in S36 is passed to the print processing sequence (S39). To be more specific, when the image management application program P1 is launched, a print processing sequence controlled by the printer driver P4 is launched, and the original images of the raster image files associated with the thumbnail images 103, 104, and 105 clicked in the subwindow 101 are decoded, rasterized, and passed to the printer driver P4.

The processing sequence launched by the image management application program P1 when the image management application program P1 is launched depends on the cause of the launch of the image management application program P1. In other words, in the case where the image management application program P1 has been launched from the storage page 70 of the device browser P31 via the printer page 60, the print processing sequence is launched by the image management application program P1, and the processing target selected in the window 100 displayed by the HDD driver P6 is passed to the print processing sequence. However, this processing is not executed in the case where the image management application program has not been launched from the storage page 70 of the device browser P31 via the printer page 60.

A process that causes the processing sequences launched by the image management application program P1 to branch can be realized, for example, as follows. First, a function for monitoring the icons that are clicked in the storage page 70 displayed by the device browser P31 is added to the device launching control module P12 of the image management application program P1, and the device launching control module P12 is launched and runs in the background immediately after the PC 1 is started up. Identification information that specifies the cause of the launch in accordance with the icons clicked in the storage page 70 (for example, an identifier of the icon 72 displayed in the printer page 70) is obtained from the device browser P31 and stored in a predetermined region of the RAM 11. Furthermore, identification information by which the device launching control module P12 specifies the cause of the launch when the image management application program P1 is launched (for example, the file path of the printer page 60, an identifier of the printer 2, or the like) is obtained from the device browser P31 and stored in a predetermined region of the RAM 11. Then, when the image management module P13 is launched, the respective pieces of identification information stored in those two predetermined regions are obtained, and the processing is caused to branch based on a combination of the obtained identification information.

Finally, the processing target selected in S36 is printed by the print processing sequence that has been launched (S9).

According to the third embodiment of the peripheral device control process described thus far, if a user selects an image and selects a processing sequence for printing in the storage page 70 in which processing sequences associated with both the storage device 3 and the printer 2 are displayed as choices, selects a processing target in the window 100 displayed by the HDD driver P6, and selects an image and selects a processing sequence for printing in the printer page 60, it is unnecessary to once again select a processing target using a GUI of the image management application program P1, once again select a print processing sequence unique to the printer 2, and so on.

Furthermore, according to the third embodiment of the peripheral device control process as described thus far, when a processing target is selected in the window 100 displayed by the HDD driver P6, the printer page 60 is displayed, and therefore when a processing sequence aside from printing has been selected for the processing target, it is possible to launch the selected processing sequence aside from printing and pass the processing target thereto. For example, in the case where an icon 63 described by text reading “copy to removable memory” has been clicked in the printer page 60, it is possible to launch the memory driver P5, passed the processing target to the memory driver P5, and copy the processing target into a specific folder.

### D Other Embodiments

It should be noted that the technical scope of the invention is not intended to be limited to the aforementioned embodiments, and it goes without saying that various modifications can be made without departing from the essential spirit of the invention.

For example, although the invention is described using the printer 2 and a storage device 3 as examples of devices (peripheral devices) connected to the PC 1, it goes without saying that the invention can be applied using any device as long as the device is a device that displays associated multiple processing sequences as a menu of choices using a browser. Furthermore, although the invention is described using the image management application program P1 and the HDD driver P6 as examples of application programs, the invention can be applied using any application program as long as the application program includes a function for launching processing sequences undertaken by devices. For example, the invention may be applied to an application program whose processing target is the text file extension “.txt” (for example, a word processor) associated with a shortcut icon 94 illustrated in FIG. 4A in the second embodiment.

What is claimed is:

1. A recording medium having a computer program recorded thereon for causing a computer to execute:
a processing sequence launching section that, in the case where in a menu in which processing sequences associated with a first device are displayed as choices by a browser, a processing sequence from among the processing sequences associated with the first device is selected, launches the selected processing sequence;
a processing target candidate selection display section that displays a list of processing target candidates as choices; and
a processing target specification section that, in the case where one or more of the processing target candidates have been selected, passes the selected processing target candidate as a processing target to the processing sequence launched by the processing sequence launching section.

2. The recording medium according to claim 1,
wherein the processing target candidate selection display section displays the list of processing target candidates as choices after the processing sequence launching section has launched the selected processing sequence.

3. A recording medium having a computer program recorded thereon for causing a computer to execute:
a processing target candidate selection display section that, in the case where in a second device menu in which processing sequences associated with a second device are displayed as choices by a browser, a processing sequence from among the processing sequences associated with the second device that is also associated with a first device is selected, displays processing target candidates stored in the second device as a list of choices;
a processing target specification section that specifies one or more of the processing target candidates as a processing target;
a browser control section that, after the processing target has been specified by the processing target specification section, causes the browser to be displayed as a first device menu of processing sequences associated with the first device;
a processing sequence launching section that selects, from the first device menu displayed by the browser control section, a processing sequence associated with the first device and launches the selected processing sequence; and
a passing section that, in the case where the processing sequence launched by the processing sequence launching section is the same processing sequence that has been selected in the second device menu, passes the processing target specified by the processing target specification section to the processing sequence launched by the processing sequence launching section.
